(19) United States
(12) Patent Application Publication
(10) Pub. No.: US 2012/0200186 A1
(43) Pub. Date: Aug. 9, 2012

(54) ROTOR FOR ELECTRIC ROTATING MACHINE

(75) Inventors: Shinya SANO, Toyota-shi (JP); Ken TAKEDA, Anjo-shi (JP); Tomohiro INAGAKI, Nishio-shi (JP); Shinichi OTAKE, Aichi-ken (JP); Tsuyoshi MIYAJI, Toyohashi-shi (JP); Yuta WATANABE, Nishio-shi (JP); Toshihiko YOSHIDA, Kariya-shi (JP); Yoichi SAITO, Kariya-shi (JP)

(73) Assignees: TOYOTA JIDOSHA KABUSHIKI KAISHA, Toyota-shi (JP); KABUSHIKI KAISHA TOYOTA JIDOSHOKKI, Kariya-shi (JP); AISIN AW CO., LTD., Anjo-shi (JP)

(21) Appl. No.: 13/364,413

(22) Filed: Feb. 2, 2012

(30) Foreign Application Priority Data
Feb. 3, 2011 (JP) 2011-021404

(51) Int. Cl. H02K 1/27

(52) U.S. Cl. 310/156.01

(57) ABSTRACT

An iron rotor core includes a first permanent magnet in an outer peripheral portion of the iron rotor core, second permanent magnets on both circumferential sides of the first permanent magnet and arranged in a generally V-shaped configuration opening radially outward, and a first region provided opposite to the first permanent magnet radially inside the region between the second permanent magnets and having a low magnetic permeability. A q-axis magnetic flux path is formed in an iron core region among the first permanent magnet, the second permanent magnets and the first region, and a central portion thereof is formed between the first permanent magnet and the first region, and entrance/exit portions of the q-axis magnetic flux path formed between the second permanent magnets and second regions provided on both circumferential sides of the first permanent magnet and having a low magnetic permeability with generally the same width.

### INCORPORATION BY REFERENCE

The disclosure of Japanese Patent Application No. 2011-021404 filed on Feb. 3, 2011 including the specification, drawings and abstract is incorporated herein by reference in its entirety.

### BACKGROUND OF THE INVENTION

1. Field of the Invention

The present invention relates to a rotor for an electric rotating machine, and, more particularly, to a rotor for an electric rotating machine that includes a plurality of permanent magnets which are embedded in the outer peripheral portion of an iron rotor core in a circumferentially spaced relationship.

2. Description of the Related Art

As a related art, a rotor 80 for an electric motor as shown in FIG. 3 that is disclosed in Japanese Patent Application Publication No. 2003-134704 (JP-A-2003-134704), for example, is known. FIG. 3 is a diagram that illustrates part of the rotor 80, in other words, one-quarter (90° region) of its cross-section perpendicular to the axis of a shaft 82.

In FIG. 3, the rotor 80 includes a rotatably-supported shaft 82 as a rotating shaft of the rotor, an iron rotor core 84 secured to the shaft 82, a plurality of permanent magnets 86 (only one of which is shown in FIG. 3) provided in the iron rotor core 84 along the outer periphery thereof, two permanent magnets 88a and 88b that have a rectangular cross-section and are arranged radially inside the permanent magnet 86 in a generally V-shaped configuration in the iron rotor core 84, and permanent magnets 90a and 90b that are located radially inside the permanent magnets 88a and 88b, respectively.

The iron rotor core 84 is formed by axially laminating a multiplicity of magnetic steel sheets. The permanent magnet 86 and the two permanent magnets 88a and 88b, which are arranged in a V-shaped configuration, are magnets that have a high magnetic flux density, such as neodymium magnets. The permanent magnets 90a and 90b are, for example, ferrite magnets which have a lower magnetic flux density than the permanent magnet 86 and the permanent magnets 88a and 88b. The permanent magnets 88a and 88b are placed in contact with each other at one corner.

It is stated that because the permanent magnets 90a and 90b, which are located radially inside the permanent magnets 88a and 88b and have a lower magnetic flux density than the permanent magnets 88a and 88b, decrease the d-axis inductance Ld, and prevent magnetic saturation between the permanent magnet 86 and the permanent magnets 88a and 88b and increase the q-axis inductance Lq even if magnets that have a high magnetic flux density, such as neodymium magnets, are used as the permanent magnet 86 and the permanent magnets 88a and 88b, the rotor 80, which has the above configuration, can improve the output torque of an electric rotating machine in which it is equipped.

In the rotor 80 of JP-A-2003-134704, a generally triangular iron core region 92 that is surrounded by the permanent magnet 86 and the permanent magnets 88a and 88b, which are arranged in a generally V-shaped configuration on both sides of the permanent magnet 86, is included as part of a q-axis magnetic flux path, which is indicated by dot-and-dash lines. In this case, because the magnetic flux path is narrow at an entrance portion 94a and an exit portion 94b, the q-axis magnetic flux tends to be saturated in these portions. In particular, this tendency is stronger when magnets with a high magnetic flux density, such as neodymium magnets, are used as the two permanent magnets 88a and 88b, which are arranged in a generally V-shaped configuration.

Another problem is that because the q-axis magnetic flux does not flow smoothly or at all through the generally triangular iron core region 92 as a central portion of the q-axis magnetic flux path, the iron core region with a limited size or cross-sectional area is not used effectively.

### SUMMARY OF THE INVENTION

In view of the above problems, the present invention provides a rotor for an electric rotating machine which can provide a high-torque output by using the iron core region with a limited size effectively to increase the q-axis inductance Lq.

According to one aspect of the present invention, a rotor for an electric rotating machine is provided which includes an iron rotor core, and a plurality of magnetic poles that are provided in an outer peripheral portion of the iron rotor core in a circumferentially spaced relation. Each of the magnetic poles of the rotor for an electric rotating machine includes a first permanent magnet that is located in a circumferentially center position, second permanent magnets that are embedded on both circumferential sides of the first permanent magnet and arranged such that the distance therebetween increases radially outward; and a first region that is provided opposite to the first permanent magnet in a position radially inside the region between the second permanent magnets and has a lower magnetic permeability than the material of the iron core. A q-axis magnetic flux path is formed in an iron core region among the first permanent magnet, the second permanent magnets and the first region, and a central portion of the q-axis magnetic flux path that is formed between the first permanent magnet and the first region and entrance/exit portions of the q-axis magnetic flux path that are formed between the second permanent magnets and second regions that are provided on both circumferential sides of the first permanent magnet and have a lower magnetic permeability than the material of the iron core are set to have generally the same width.

In the rotor for an electric rotating machine, the first region and the second region may contain at least one of a hollow cavity or a resin.

In the rotor for an electric rotating machine, the first region may include two first holes that are formed in communication with the radially inner end of corresponding one of the second magnet insertion holes in which the second permanent magnets are inserted and a second hole that is formed between the first holes and separated from the first holes by bridge portions, and the second hole may have generally the same width as the first permanent magnet.

In the rotor for an electric rotating machine, the second regions may be provided in positions on both circumferential sides of the first permanent magnet and radially outside the first permanent magnet and are spaced apart from a first magnet insertion hole in which the first permanent magnet is inserted, and the entrance/exit portions of the q-axis magnetic flux path may be formed between the second permanent magnets and the second regions.

In the rotor for an electric rotating machine, the first permanent magnet and the second permanent magnet may have the same shape and size.

According to the rotor for an electric rotating machine of the present invention, a q-axis magnetic flux path is formed among the first permanent magnet, the second permanent magnets and the first region, and the central portion of the q-axis magnetic flux path that is formed between the first permanent magnet and the first region and the entrance/exit portions of the q-axis magnetic flux path, which are formed between the second permanent magnets and the second region that are formed on both circumferential sides of the first permanent magnet, are set to have generally the same width. Therefore, magnetic saturation in the q-axis magnetic flux path entrance/exit portions can be prevented and the iron core region that extends from the entrance/exit portions of the q-axis magnetic flux path to the central portion of the q-axis magnetic flux path can be used effectively as a q-axis magnetic flux path, which results in an increase in q-axis inductance and an increase in reactance torque. As a result, a high-torque output can be achieved efficiently.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is an axial cross-sectional view of a rotor as one embodiment of the present invention;

FIG. 2A is a partial enlarged view that illustrates one magnetic pole in an iron rotor core that forms the rotor of FIG. 1;

FIG. 2B is an enlarged view, similar to FIG. 2A, that schematically illustrates the flow of q-axis magnetic flux in one magnetic pole in an iron rotor core of a related art; and

FIG. 3 is a partial enlarged view that illustrates the configuration of one magnetic pole and the d- and q-axis magnetic flux paths in a rotor of a related art.

### DETAILED DESCRIPTION OF EMBODIMENTS

Description is hereinafter made of an embodiment of the present invention in detail with reference to the accompanying drawings. It should be noted that the specific shapes, materials, numerical values, directions, and so on in this description are examples to facilitate understanding of the present invention, and can be changed as needed depending on the use, purpose, specification, and so on.

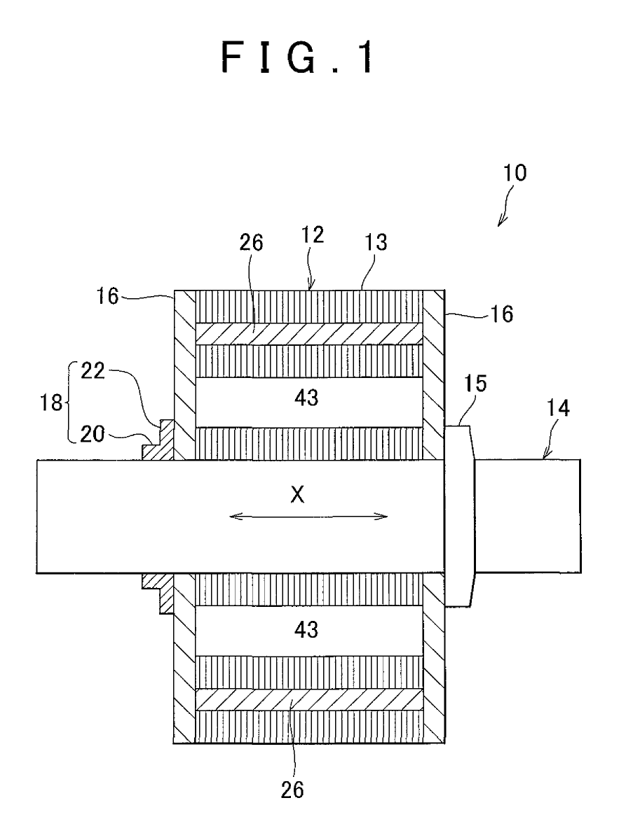

FIG. 1 is an axial cross-sectional view of a rotor 10 for an electric rotating machine (which may be hereinafter referred to simply as “rotor” as needed) of this embodiment. A cylindrical stator (not shown) is provided around the rotor 10. The stator forms a magnetic field that rotatably drives the rotor 10.

The rotor 10 includes a columnar or cylindrical columnar iron rotor core 12 that has a central hole, a shaft 14 that fixedly extends through the central hole of the iron rotor core 12, end plates 16 that are disposed in contact with both side of the iron rotor core 12 in the axial direction of the shaft 14 (and the iron rotor core 12), which is indicated by an arrow X, and a securing member 18 that secures the iron rotor core 12 and the end plates 16 to the shaft 14.

The iron rotor core 12 is formed by axially laminating a multiplicity of annular magnetic steel sheets, each of which is formed by punching a silicon steel plate or the like with a thickness of, for example, 0.3 mm. The magnetic steel sheets that form the iron rotor core 12 are integrally joined together in each of a plurality of blocks that are formed by axially dividing the iron rotor core 12 or joined into a unitary body by a suitable method such as swaging, bonding or welding. The iron rotor core 12 has a plurality of magnetic poles that are provided in a circumferentially equally spaced relationship. Each of the magnetic poles includes a plurality of permanent magnets, the details of which are described later.

The shaft 14 is formed of a steel round bar, and has a flange portion 15 that extends radially outward from an outer periphery thereof. The flange portion abuts against one of the end plates 16 and serves as an abutting portion that determines the axial position of the iron rotor core 12 on the shaft 14 when the rotor 10 is assembled. A key groove that is used to fix the circumferential position of the iron rotor core 12 may be axially formed in an outer surface of the shaft 14.

Each of the end plates 16 is formed of a circular plate that has substantially the same outer shape as the axial end faces of the iron rotor core 12. The end plates 16 are suitably made of a nonmagnetic metal material such as aluminum or copper. The reason why the end plates 16 are made of a nonmagnetic metal is to prevent a short-circuit of magnetic flux between the axial ends of the permanent magnets that form the magnetic poles. However, the end plates 16 are not necessarily made of a metal material as long as they are made of a nonmagnetic material. For example, the end plates 16 may be made of a resin material.

The end plates 16, which are located at both axial ends of the iron rotor core 12, have a function of holding the iron rotor core 12 from both sides, a function of being partially cut to correct imbalance of the rotor 10 after the assembly of the rotor 10, a function of preventing the permanent magnets that form the magnetic poles from axially thrusting out from the iron rotor core 12, and so on.

While description and illustration are made on the assumption that the end plates 16 have a diameter that is substantially the same as that of the iron rotor core 12 in this embodiment, the end plates may be smaller in diameter or eliminated for cost reduction when the permanent magnets that form the magnetic poles are fixed in the iron rotor core by a resin or the like.

The securing member 18 includes a cylindrical swaging portion 20 and a pressing portion 22 that extends radially outward from one end of the swaging portion 20. The securing member 18 is secured to the shaft 14 by swaging the swaging portion 20 onto the shaft 14 with the iron rotor core 12 and the two end plates 16 pressed toward the flange portion 15 by the pressing portion 22. As a result, the iron rotor core 12 is secured to the shaft 14 together with the end plates 16.

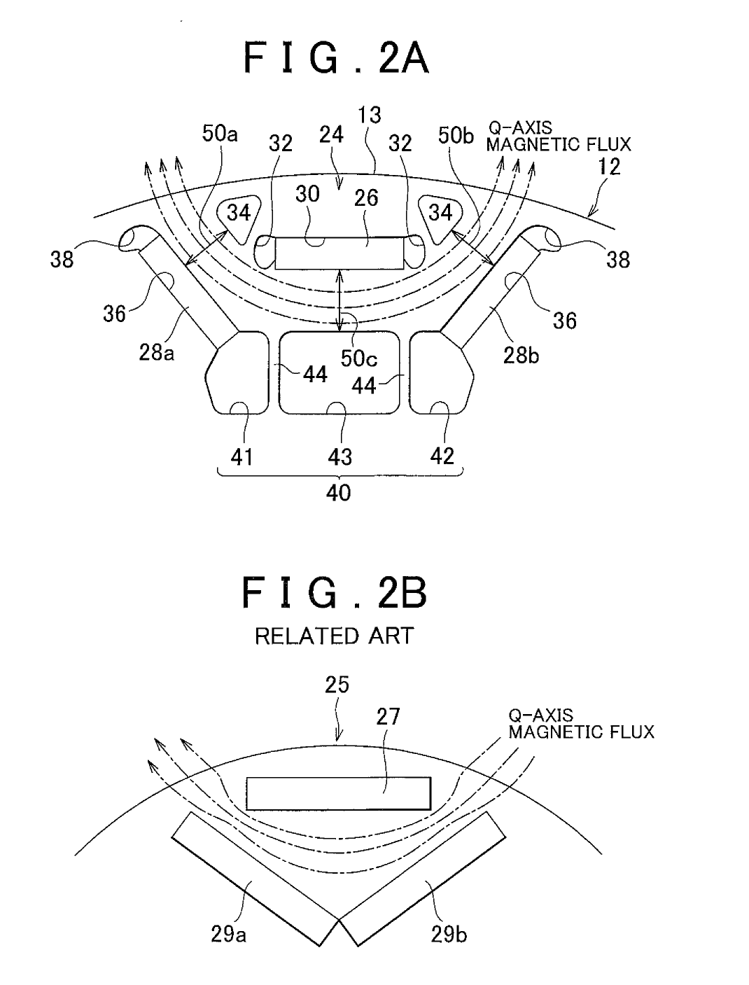

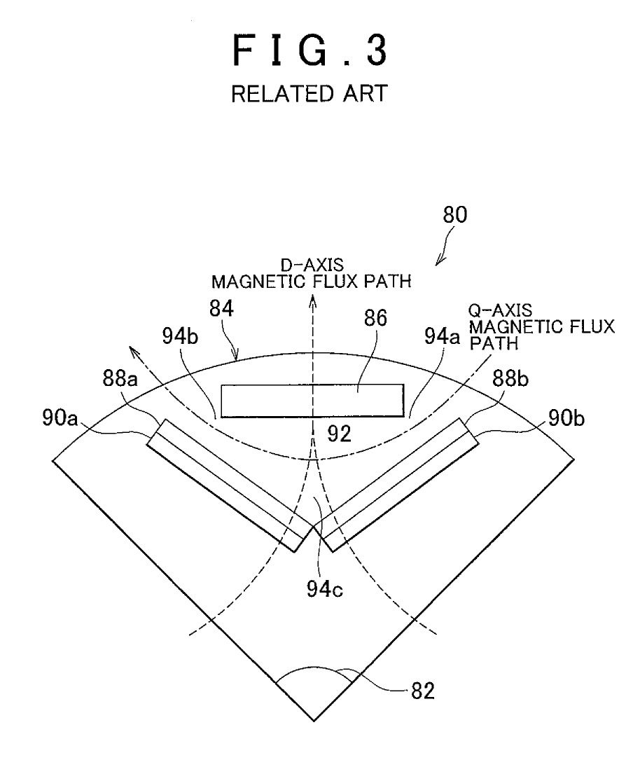

Referring next to FIG. 2A, the configuration of the magnetic poles included in the iron rotor core 12 is described. FIG. 2A is an enlarged view that illustrates one magnetic pole 24 that are seen when an axial end face of the iron rotor core 12 is viewed. The magnetic pole 24 has the same configuration when the iron rotor core 12 is viewed in a cross-section perpendicular to its axial direction.

The iron rotor core 12 has, for example, eight magnetic poles 24 that are arranged in a circumferentially equally spaced relationship. Each of magnetic poles 24 includes one first permanent magnet 26 and two second permanent magnets 28a and 28b. The first permanent magnet 26 is embedded in the iron rotor core 12 at a position in the vicinity of an outer peripheral surface 13 thereof and at the circumferential center of the magnetic pole 24.

The first permanent magnet 26 has elongated rectangular end faces (and a cross-section) that have two short sides and two long sides, and has substantially the same axial length as the iron rotor core 12. The first permanent magnet 26 is axially inserted in a first magnet insertion hole 30 that is formed through the iron rotor core 12 and fixed by, for example, a thermosetting resin that is injected into narrow gaps between the long-side lateral faces of the first permanent magnet 26 and the internal surfaces of the hole. The first permanent magnet 26 is disposed with its long-side lateral faces extending generally along the outer peripheral surface 13 of the iron rotor core 12.

Two pocket portions 32 are formed in communication with the first magnet insertion hole 30 on both circumferential sides of the first magnet insertion hole 30. The pocket portions 32 extend axially along the short-side lateral faces of the first permanent magnet 26. The pocket portions 32 contains a hollow cavity or resin, which has a lower magnetic permeability than the magnetic steel sheets that form the iron rotor core 12, and therefore has a function of preventing a short-circuit of magnetic flux at ends of the first permanent magnet 26 in the direction of its long sides and a function of defining part of a q-axis magnetic flux path. The resin that is used to fix the first permanent magnet 26 may be injected through at least one of the pocket portions 32.

Two outer periphery-side holes (second regions) 34 are formed at positions in the vicinity of the pocket portions 32 and close to the outer periphery of the iron rotor core 12. The outer periphery-side holes 34 are formed on both circumferential sides of the first permanent magnet 26 and spaced apart from the first magnet insertion hole 30 and the pocket portions 32. The outer periphery-side holes 34 contains a hollow cavity, which has a lower magnetic permeability than the magnetic steel sheets that form the iron rotor core 12, and therefore define low magnetic permeability regions. As described later, entrance/exit portions 50a and 50b of the q-axis magnetic flux path are formed in the iron core region between the outer periphery-side holes 34 and the second permanent magnets 28a and 28b.

It should be noted that while the outer periphery-side holes 34 are formed apart from the pocket portions 32 that are communicated with the first magnet insertion hole 30 in this embodiment, the present invention is not limited thereto and the outer periphery-side holes 34 may be formed in communication with the pocket portions 32, which form part of the first magnet insertion hole 30. In addition, the outer periphery-side holes 34 may be filled with a material that has a lower magnetic permeability than the magnetic steel sheets, such as a low-magnetic permeability resin material.

The second permanent magnets 28a and 28b are embedded on both circumferential sides of the first permanent magnet 26 and arranged in a generally V-shaped configuration that opens toward the outer peripheral surface 13. The second permanent magnets 28a and 28b preferably have the same shape and size as the first permanent magnet 26. The second permanent magnets 28a and 28b are axially inserted in second magnet insertion holes 36 and fixed therein in the same manner as the first permanent magnet 26.

Pocket portions 38 are formed radially outside the second permanent magnets 28a and 28b in communication with the corresponding one of the second magnet insertion holes 36. The pocket portions 38 contains a hollow cavity or resin, which has a low magnetic permeability, and therefore have a function of preventing a short-circuit of magnetic flux at the radially outside ends of the second permanent magnets 28a and 28b in the direction of their long sides, and a function of defining ends of the entrance/exit portions of the q-axis magnetic flux path. The resin that is used to fix the second permanent magnets 28a and 28b may be injected through the pocket portions 38.

A low magnetic permeability region (first region) 40 that includes three holes 41, 42 and 43 is formed in a position radially inside the region between the second permanent magnets 28a and 28b. Each of the holes 41, 42 and 43 contains a hollow cavity (or resin), which has a lower magnetic permeability than the magnetic steel sheets, and therefore forms a low magnetic permeability region. Each of first holes 41 and 42 is formed in communication with the radially inner end of corresponding one of the second magnet insertion holes 36, in which the second permanent magnets 28a and 28b are inserted. The first holes 41 and 42 have a function of preventing a short-circuit of magnetic flux at the radially inner ends of the second permanent magnets 28a and 28b in the direction of their long sides, and a function of defining part of the q-axis magnetic flux path.

A second hole 43 is formed between the first holes 41 and 42 and separated from the first holes 41 and 42 by bridge portions 44. The second hole 43 is a generally rectangular hole that extends in parallel to the first permanent magnet 26, and is opposed to the first permanent magnet 26 via a central portion 50c of the q-axis magnetic flux path. In addition, the second hole 43 preferably has substantially the same width as the first permanent magnet 26. The second hole 43 with such a width can effectively decrease the d-axis inductance Ld in the d-axis magnetic flux path that is formed radially through the first permanent magnet 26 and contribute to improvement of reactance torque.

In the iron rotor core 12 of this embodiment, which is constituted as described above, a q-axis magnetic flux path is formed in the iron core region among the first permanent magnet 26, the pocket portions 32, the outer periphery-side holes 34, the second permanent magnets 28a and 28b, and the first region 40. Specifically, a central portion of the q-axis magnetic flux path is formed between the first permanent magnet 26 and the second hole 43 of the low magnetic permeability region 40, and entrance/exits portions 50a and 50b of the q-axis magnetic flux path are formed between the second permanent magnets 28a and 28b and the outer periphery-side holes 34. A feature of this embodiment is that the central portion 50c and the entrance/exit portions 50a and 50b of the q-axis magnetic flux path are set to have the same or substantially the same width.

The width of a magnetic flux path is its width or length in the direction generally perpendicular to the q-axis magnetic flux that passes the magnetic flux path (the dot-and-dash lines in FIG. 2A). In FIG. 2A, an entrance portion of the q-axis magnetic flux path is formed between the second permanent magnet 28b and the outer periphery-side hole 34 on the right side, and an exit portion of the q-axis magnetic flux path is formed between the second permanent magnet 28a and the outer periphery-side hole 34 on the left side. However, because the q-axis magnetic flux may pass in the opposite direction to the direction that is shown in FIG. 2B depending on the excitation state of the stator (not shown) and the rotational position of the rotor 10, the term “entrance/exit portions of the q-axis magnetic flux path” is used.

As described above in connection with the background art, in a rotor that includes ordinary magnetic poles 25 that have three permanent magnets as shown in FIG. 2B, the entrance/exit portions of the q-axis magnetic flux path that are formed between the circumferential ends of the first permanent magnet 27 and the second permanent magnets 29a and 29b are narrow and the central portion of the q-axis magnetic flux path that is formed among the circumferential central portion of the first permanent magnet 27 and the second permanent magnets 29a and 29b is wide. Thus, magnetic saturation tends to occur in the entrance/exit portions of the q-axis magnetic flux path, and the generally triangular iron core region that is surrounded by the first and second permanent magnets is not used effectively as a q-axis magnetic flux path.

On the contrary, according to the rotor 10 of this embodiment, the central portion 50c and the entrance/exit portions 50a and 50b of the q-axis magnetic flux path have generally the same width in the magnetic poles 24. Thus, magnetic saturation in the entrance/exit portions 50a and 50b of the q-axis magnetic flux path can be prevented and the iron core region that extends from the entrance/exit portion 50a (or 50b) of the q-axis magnetic flux path to the central portion 50c of the q-axis magnetic flux path can be used effectively as a q-axis magnetic flux path. As a result, because the q-axis inductance Lq increases and the reactance torque increases, a high-torque output can be achieved even when the current through the stator winding is the same.

In addition, placing the second hole 43 with substantially the same width as the first permanent magnet 26 opposite the first permanent magnet 26 at a position radially inside the first permanent magnet 26 to decrease the d-axis inductance Ld effectively leads to an increase in reactance torque, which increases in proportion to the difference between the d-axis inductance Ld and the q-axis inductance Lq (absolute value of “Ld−Lq”).

In other words, because the amount of permanent magnet necessary to achieve the same torque can be reduced, the cost for magnet can be reduced. in addition, when the first and second permanent magnets 26, 28a and 28b have the same shape and size, the cost necessary to produce and control the magnets can be reduced and the magnets can be assembled into the iron rotor core easily and quickly.

In the above embodiment, various changes and modifications can be made. For example, while the low magnetic permeability region 40 includes three holes 41, 42 and 43 in the above embodiment, the present invention is not limited thereto.

The low magnetic permeability region 40 may include two holes that are separated by one bridge portion, or may have only one hole with no bridge portion.

While the invention has been described with reference to example embodiments thereof, it is to be understood that the invention is not limited to the example described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A rotor for an electric rotating machine, comprising:
an iron rotor core; and
a plurality of magnetic poles that are provided in an outer peripheral portion of the iron rotor core in a circumferentially spaced relation,
wherein each of the magnetic poles comprises a first permanent magnet that is located in a circumferentially center position,
second permanent magnets that are embedded on both circumferential sides of the first permanent magnet and arranged such that the distance therebetween increases radially outward; and
a first region that is provided opposite to the first permanent magnet in a position radially inside the region between the second permanent magnets and has a lower magnetic permeability than the material of the iron core, and
wherein a q-axis magnetic flux path is formed in an iron core region among the first permanent magnet, the second permanent magnets and the first region, and a central portion of the q-axis magnetic flux path that is formed between the first permanent magnet and the first region and entrance/exit portions of the q-axis magnetic flux path that are formed between the second permanent magnets and second regions that are provided on both circumferential sides of the first permanent magnet and have a lower magnetic permeability than the material of the iron core are set to have generally the same width.

2. The rotor for an electric rotating machine according to claim 1,
wherein the first region and the second regions contain at least one of a hollow cavity or a resin.

3. The rotor for an electric rotating machine according to claim 2,
wherein the first region includes two first holes that are formed in communication with the radially inner end of corresponding one of the second magnet insertion holes in which the second permanent magnets are inserted and a second hole that is formed between the first holes and separated from the first holes by bridge portions, and the second hole has generally the same width as the first permanent magnet.

4. The rotor for an electric rotating machine according to claim 2,
wherein the second regions are provided in positions on both circumferential sides of the first permanent magnet and radially outside the first permanent magnet and are spaced apart from a first magnet insertion hole in which the first permanent magnet is inserted, and the entrance/exit portions of the q-axis magnetic flux path are formed between the second permanent magnets and the second regions.

5. The rotor for an electric rotating machine according to claim 2,
wherein the first permanent magnet and the second permanent magnets have the same shape and size.

6. The rotor for an electric rotating machine according to claim 1,
wherein the first region includes two first holes that are formed in communication with the radially inner end of corresponding one of the second magnet insertion holes in which the second permanent magnets are inserted and a second hole that is formed between the first holes and separated from the first holes by bridge portions, and the second hole has generally the same width as the first permanent magnet.

7. The rotor for an electric rotating machine according to claim 6,
wherein the second regions are provided in positions on both circumferential sides of the first permanent magnet and radially outside the first permanent magnet and are spaced apart from a first magnet insertion hole in which the first permanent magnet is inserted, and the entrance/exit portions of the q-axis magnetic flux path are formed between the second permanent magnets and the second regions.

8. The rotor for an electric rotating machine according to claim 1,
wherein the second regions are provided in positions on both circumferential sides of the first permanent magnet and radially outside the first permanent magnet and are spaced apart from a first magnet insertion hole in which the first permanent magnet is inserted, and the entrance/exit portions of the q-axis magnetic flux path are formed between the second permanent magnets and the second regions.

9. The rotor for an electric rotating machine according to claim 8,
wherein the first permanent magnet and the second permanent magnets have the same shape and size.

10. The rotor for an electric rotating machine according to claim 1,
wherein the first permanent magnet and the second permanent magnets have the same shape and size.
